(19) United States
(12) Patent Application Publication
(10) Pub. No.: US 2021/0088082 A1
(43) Pub. Date: Mar. 25, 2021

(54) PROPELLER SHAFT YOKE WITH PROTECTIVE SHOULDER FOR DAMPER

(71) Applicant: Neapco Intellectual Property Holdings, LLC, Farmington Hills, MI (US)

(72) Inventors: Carson Budde, Commerce Twp., MI (US); James B. White, Windsor (CA); Robert J. Wehner, Livonia, MI (US)

(21) Appl. No.: 17/025,085

(22) Filed: Sep. 18, 2020

Related U.S. Application Data
(60) Provisional application No. 62/903,185, filed on Sep. 20, 2019.

(51) Int. Cl. F16D 3/06; F16C 3/02

(52) U.S. Cl. CPC F16D 3/06; F16C 2326/06; F16C 3/02

(57) ABSTRACT

A propeller shaft assembly includes a propeller shaft extending along an axis between a first and second shaft ends. A propeller shaft yoke, such as a slip yoke, stud yoke, or flange yoke, is operably connected to one of said first or second shaft ends. The propeller shaft yoke includes a body between from a first and second yoke end and presenting a mounting surface. A tuned damper extends radially outwardly from the mounting surface to define a first damper side disposed adjacent the first yoke end and a second damper side disposed adjacent the second yoke end. A protective shoulder extends radially outwardly from the mounting surface in spaced and covering relationship with one of the first or second damper sides for protecting the tuned damper from axial forces originating from a respective first or second yoke end of the propeller shaft yoke.

### CROSS REFERENCE TO RELATED APPLICATION

The subject application claims priority to U.S. Provisional Patent Application Ser. No. 62/903,185 filed on Sep. 20, 2019, the entire disclosure of which is hereby incorporated by reference.

### BACKGROUND OF THE INVENTION

### 1. Field of the Invention

The present disclosure relates generally to single or multi-piece propeller shafts. More particularly, the present disclosure relates to a tuned damper for a single or multi-piece propeller shaft.

### 2. Description of the Related Art

This section of the written disclosure provides background information related to propeller shafts which is not necessarily prior art to the inventive concepts disclosed and claimed in this application.

Technological advancements continue to improve the performance of automobiles, including the reduction of noise and vibration due to rotating components, such as driveline components. Dampers, such as tuned dampers (e.g., to dampen torsional, radial, and/or axial vibrations), are used on automobile driveline components, such as, but not limited to, propeller shafts to reduce noise and/or vibration that may occur during operation of the automobile driveline. Tuned dampers may be disposed at various locations on propeller shafts due to a number of factors, such as clearance of other surrounding driveline components throughout the operational range of the automobile. Some propeller shafts are configured in more than one piece (i.e., multi-piece), due to driveline configurations, among other reasons. These single or multi-piece propeller shafts, particularly when utilized in truck, sport utility vehicles (SUV) and sports car applications, are often configured with a tuned damper commonly mounted to propeller shaft yokes (e.g., slip yokes, stud yokes and flange yokes), often for the purpose of absorbing torsional vibration energy originating from rotating gear teeth in axles, transmissions, or other adjacent vehicle components.

For example, with reference to FIGS. 3-4, prior art applications include integrating a tuned damper into the flange yoke (FIG. 3) or slip yoke (FIG. 4) by radial compression of a tuned elastomeric ring element. More specifically, as best illustrated in FIGS. 3 and 4, tuned dampers are commonly mounted on a machined outer surface or mounting hub of the propeller shaft yokes, and include an elastomeric or rubber damping ring, and a rigid inertia mass ring to create a tuned damper that absorbs torsional or radial vibration energy present in the driveline system. Historically, when the tuned dampers are applied to the machined outer surface or mounting hub, the rigid inertia mass ring and the elastomeric damping ring are press fit over the propeller shaft yokes, with radial compression of the elastomeric damping ring securing both the elastomeric damping ring and the rigid inertia mass ring to the propeller shaft yoke.

Friction between the elastomeric damper ring and the metal components may be reduced temporarily for assembly using a lubricant or emulsifier that evaporates or absorbs into the elastomer once assembly is complete. However, reliance on frictional forces from radial compression of the elastomeric damper ring as to the only method of securing the elastomer ring and the inertia mass ring to the propeller shaft yoke provides the potential for the tuned damper to be dislodged from the propeller shaft yoke. More specifically, if the tuned damper is struck or impacted during vehicle use or during shipping or handling of the propeller shaft, this can result in the damper inertia ring becoming dislodged from the propeller shaft yoke, causing eventual separation of the tuned damper from the propeller shaft and corresponding complaints of underbody noise.

Conventional attempts to resolve this concern involve the use of adhesive bonding between the machined outer surface of the propeller shaft yoke and the tuned damper. In other words, to improve the retention of a tuned damper to a propeller shaft yoke, the elastomeric damper ring may be adhesively bonded to the propeller shaft yoke, the mass inertia ring, or both components. This effectively increases the load required to dislodge the mass inertia ring from its intended position, by reducing the likelihood of slippage of the elastomeric damper ring, often requiring the elastomeric damper ring to be fractured or sheared at a substantially higher impact load as compared to slipping of the elastomeric damper ring when adhesive bonding is not present. However, a drawback of using adhesive is that consistent bonding to elastomeric materials requires the addition of manufacturing steps (and cost) to clean and prepare the bonding surfaces, apply the adhesive, and then cure the adhesive with heating. While this provides an increase in the force required to separate a damper inertia ring from an impact, this improvement may not be sufficient in all cases, especially where impact loads are severe.

Thus, as will be appreciated from the aforementioned disclosure, the prior art methods of attaching the tuned damper to the propeller shaft does not provide a process which is capable of protecting the tuned damper against all axial loads. As previously mentioned, if an axial load of high enough force is applied to the tuned damper and not the propeller shaft yoke, then the tuned damper may become dislodged (partially or fully), which could lead to immediate or later failure of the ring operation on the propeller shaft, with the potential to completely fall off with usage. Accordingly, there remains a need for an improved means of protecting a tuned damper secured to the propeller shaft yoke.

### SUMMARY OF THE INVENTION

This section provides a general summary of the invention and is not intended to be a comprehensive disclosure of its full scope, aspects, objectives, and/or all of its features.

In accordance with an aspect of the present disclosure, the propeller shaft yoke includes a protective shoulder extending radially outwardly from the mounting surface in spaced and covering relationship with a first or second damper side of the tuned damper to provide a mechanical shield that prevents dislodging of the tuned damper from axial forces applied during contact with another object, whether during shipping, vehicle assembly, or vehicle use. Put another way, the addition of the protective shoulder to the propeller shaft yoke provides a more robust and cost-effective method of preventing a damper inertia ring from being dislodged from an impact during vehicle use or propeller shaft shipping and handling. Additionally, use of the protective shoulder allows the tuned damper to be retained using the conventional approach involving radial compression of the tuned damper, without the added expense of preparing a mounting surface, adhesive bonding and then heat curing.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a propeller shaft assembly including a propeller shaft extending along an axis between a first shaft end and a second shaft end, with a first propeller shaft yoke operable connected to the first shaft end and a second propeller shaft yoke having a tuned damper operably connected to the second shaft end;

FIG. 2 is a perspective view of the propeller shaft assembly illustrating an alternative arrangement in which a first propeller shaft yoke having the tuned damper is operably connected to the first shaft end of the propeller shaft and a second propeller shaft yoke without a tuned damper is operably connected to the second shaft end of the propeller shaft;

FIG. 3 is a cross-sectional view of a prior art arrangement of the second propeller shaft yoke, in this view a flange yoke, illustrating a tuned damper extending radially outwardly from a mounting surface of a mounting hub;

FIG. 4 is a cross-sectional view of a prior art arrangement of the first propeller shaft yoke, in this view a slip yoke, illustrating the tuned damper extending radially outwardly from the mounting surface of the mounting hub;

FIG. 5 is a perspective view of the second propeller shaft yoke, in this view a flange yoke, illustrating a protective shoulder extending upwardly from the mounting surface of the mounting hub in spaced and covering relationship with a second side of the tuned damper;

FIG. 6 is a cross-sectional view of the flange yoke illustrated in FIG. 5;

FIG. 7 is a perspective cross-sectional view illustrating an alternative arrangement of the flange yoke in which the mounting hub is press-fit or otherwise joined to the body;

FIG. 8 is a perspective view of the second propeller shaft yoke, in this view a flange yoke, illustrating an alternative arrangement in which the protective shoulder extends upwardly from the mounting surface in spaced and covering relationship with the first side of the tuned damper;

FIG. 9 is a cross-sectional view of the flange yoke illustrated in FIG. 8.

FIG. 10 is a perspective view of the second propeller shaft yoke, in this view a flange yoke, illustrating an additional embodiment in which an axial flange extends axially from the protective shoulder in spaced and overlaying relationship with the tuned damper to additionally protect the tuned damper from radial forces;

FIG. 11 is a perspective end view of the flange yoke illustrated in FIG. 10;

FIG. 12 is a fragmentary cross-sectional view of the flange yoke illustrated in FIG. 10;

FIG. 13 a perspective view of the first propeller shaft yoke, in this view a slip yoke, illustrating the protective shoulder extending upwardly from the mounting surface of the mounting hub in spaced and covering relationship with the first side of the tuned damper;

FIG. 14 is a cross-sectional view of the slip yoke illustrated in FIG. 13;

FIG. 15 is a perspective view of the slip yoke illustrating an alternative arrangement in which the protective shoulder extends upwardly from the mounting surface in spaced and covering relationship with the second side of the tuned damper;

FIG. 16 is a cross-sectional view of the slip yoke illustrated in FIG. 15;

FIG. 17 a perspective view of the first propeller shaft yoke, in this view a stud yoke, illustrating the protective shoulder extending upwardly from the mounting surface of the mounting hub in spaced and covering relationship with the first side of the tuned damper;

FIG. 18 is a cross-sectional view of the stud yoke illustrated in FIG. 17;

FIG. 19 is a cross-sectional view of the second propeller shaft yoke, in this view a flange yoke, illustrating an additional embodiment in which the tuned damper is mounted inside an internal hub cavity and along an internal surface defined by the mounting hub; and

FIG. 20 is a cross-sectional view of the first propeller shaft yoke, in this case a slip yoke, illustrating an alternative arrangement of this additional embodiment in which the tuned damper is mounted inside the mounting hub of the slip yoke.

### DETAILED DESCRIPTION OF THE ENABLING EMBODIMENTS

Example embodiments will now be described more fully with reference to the accompanying drawings. The example embodiments are provided so that this disclosure will be thorough and fully convey the scope to those skilled in the art. Numerous specific details are set forth such as examples of specific components, devices, mechanisms, assemblies, and methods to provide a thorough understanding of various embodiments of the present disclosure. It will be apparent to those skilled in the art that specific details need not be employed, that example embodiments may be embodied in many different forms, and that neither should be construed to limit the scope of the disclosure. In some examples, well-known processes, well-known device structures, and well-known technologies are not described in detail.

Referring to the Figures, wherein like numerals indicate corresponding parts throughout the several views, a propeller shaft assembly 10 for a vehicle is provided. It should be appreciated that the subject propeller shaft assembly 10 may be employed for various vehicles, including but not limited to automobiles and recreational vehicles (RVs).

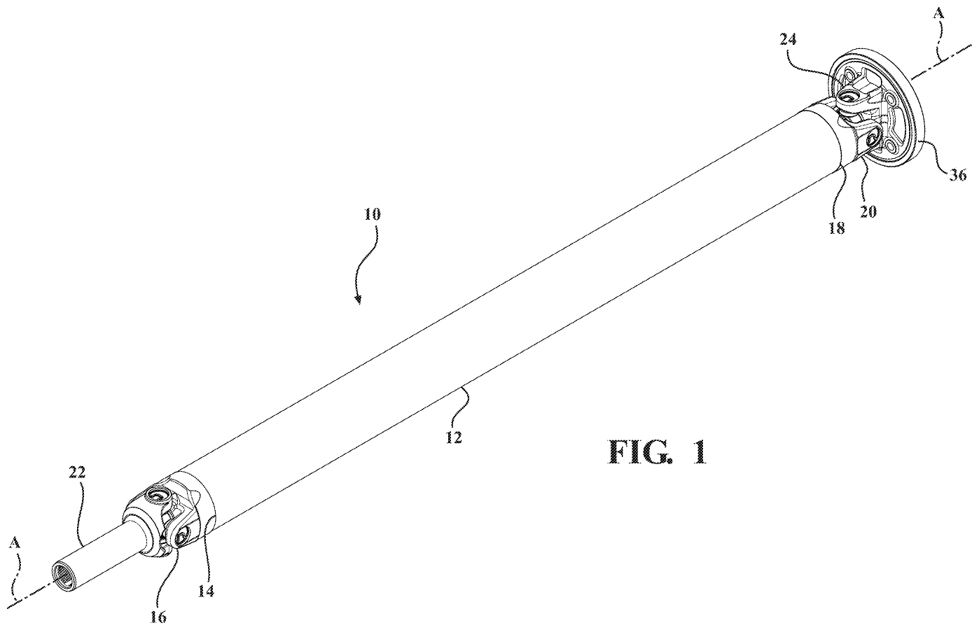

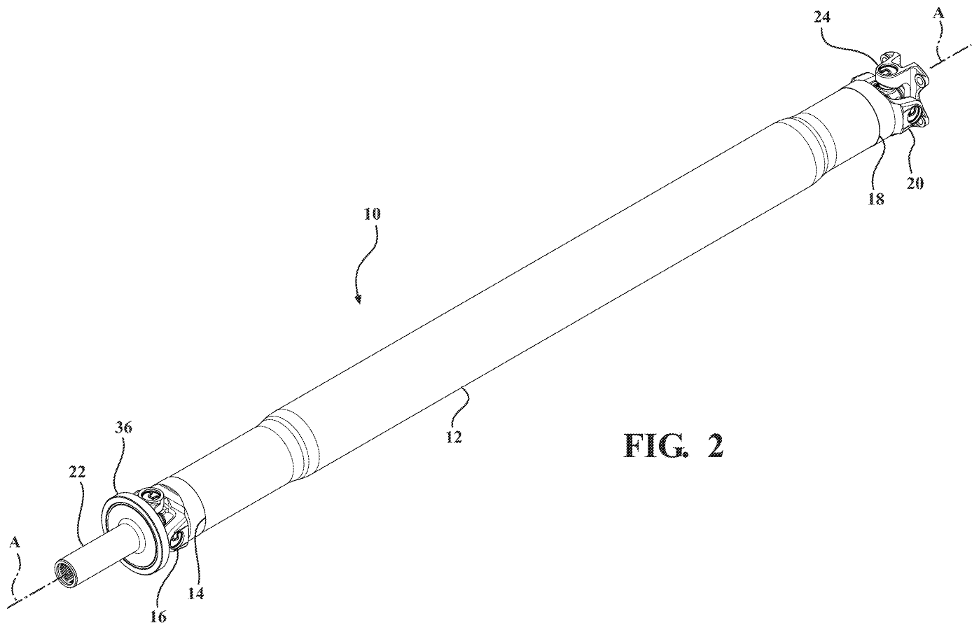

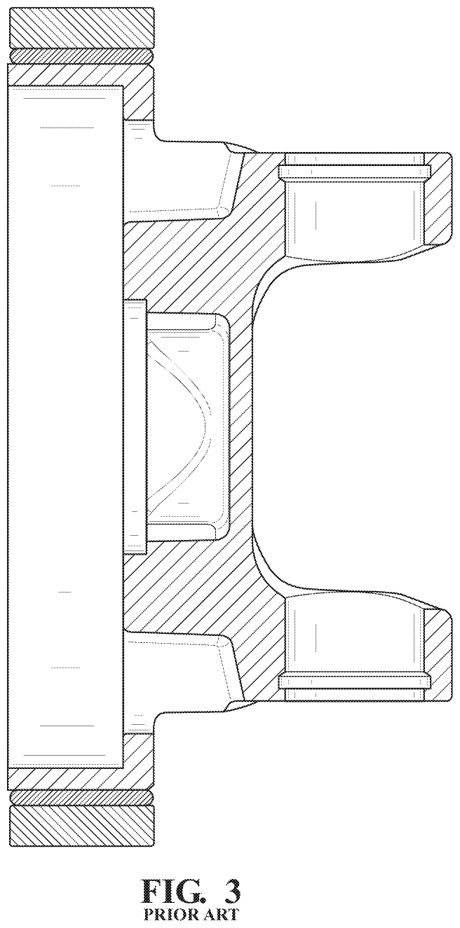

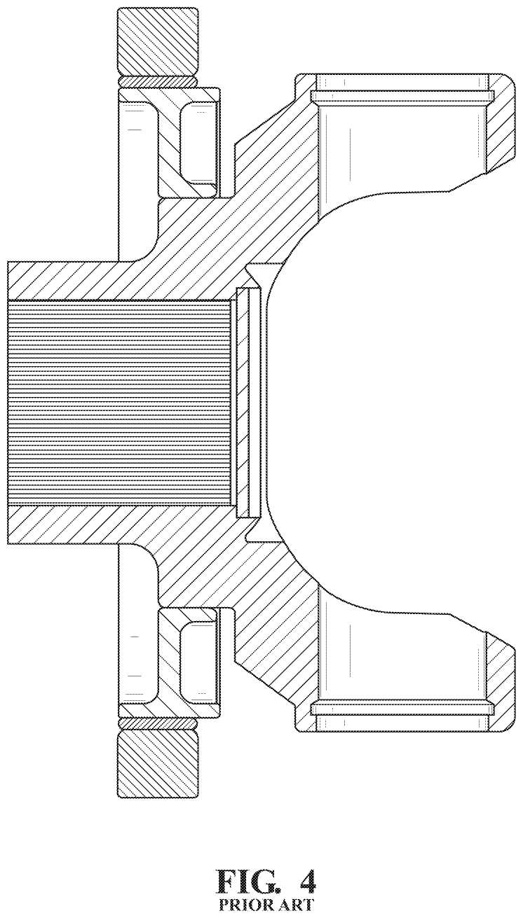

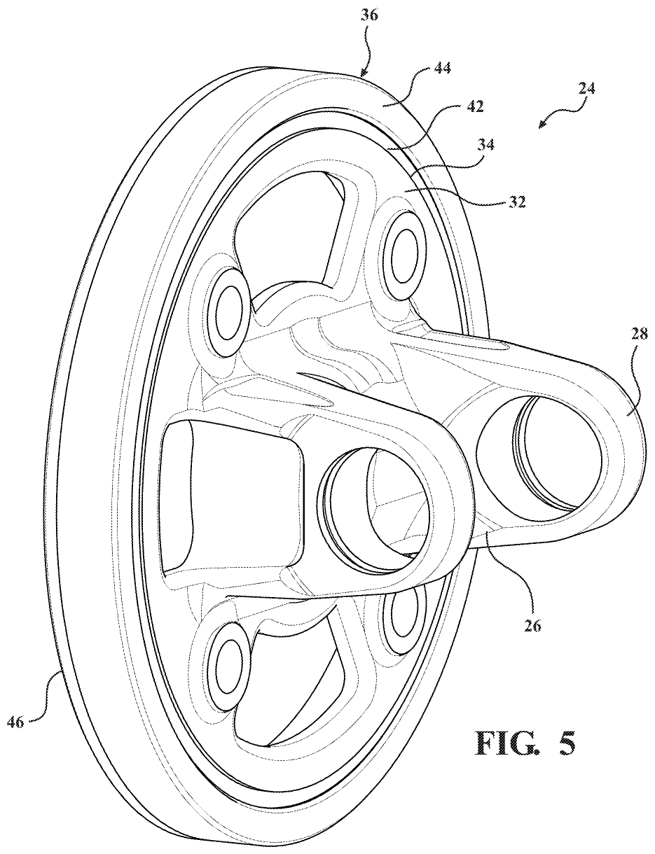

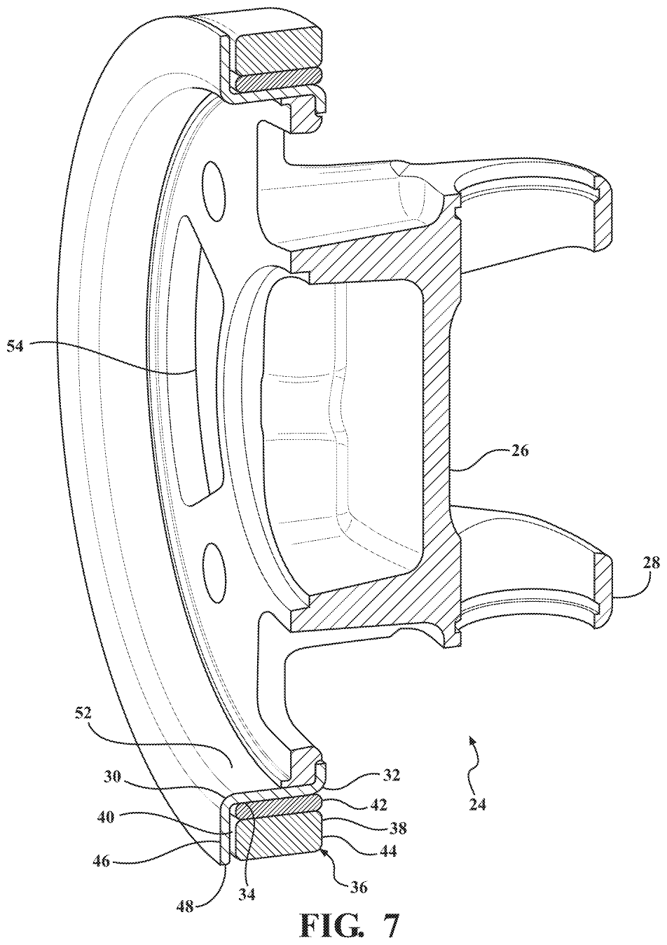

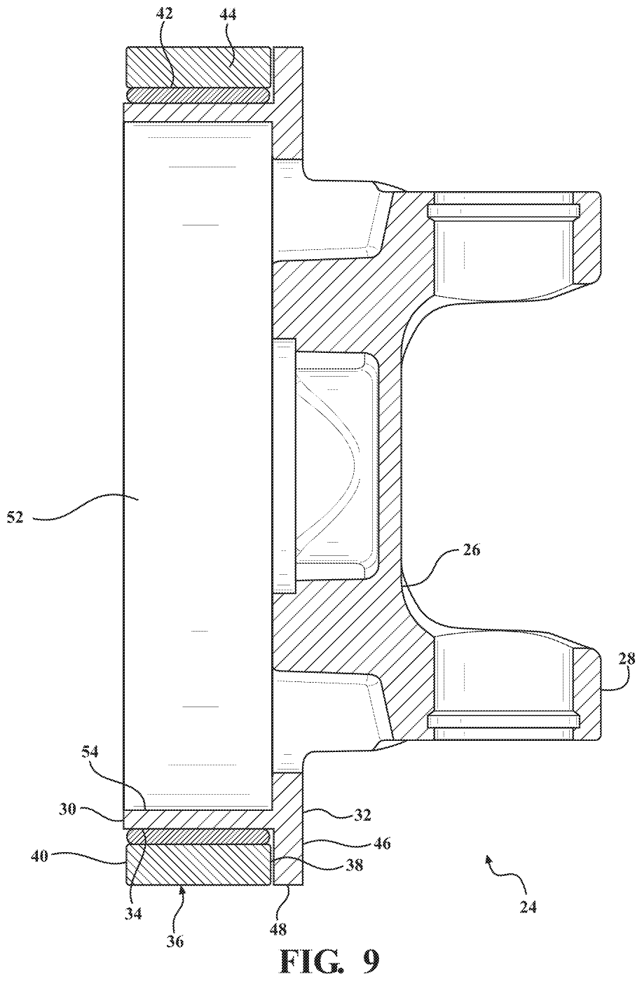

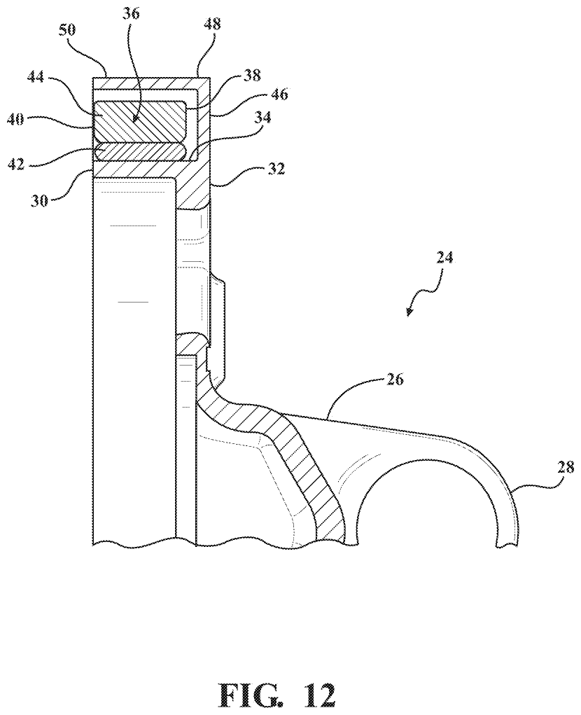

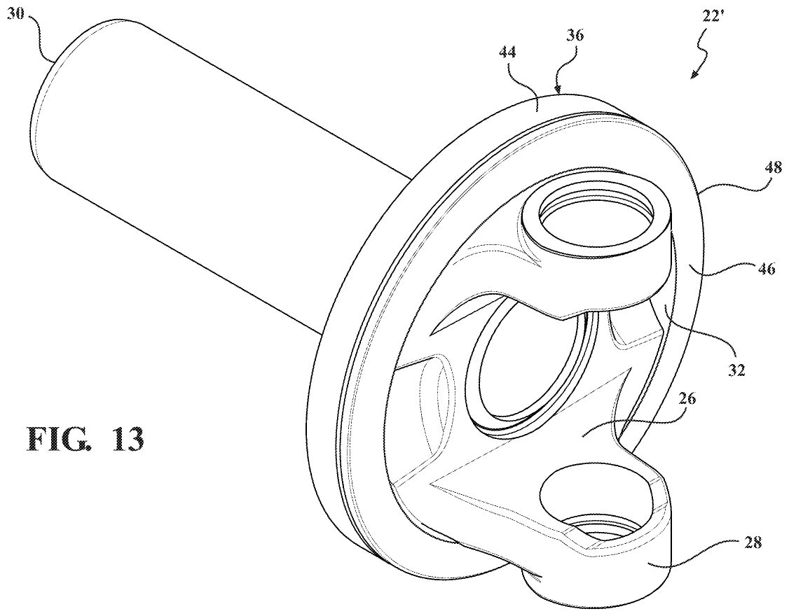

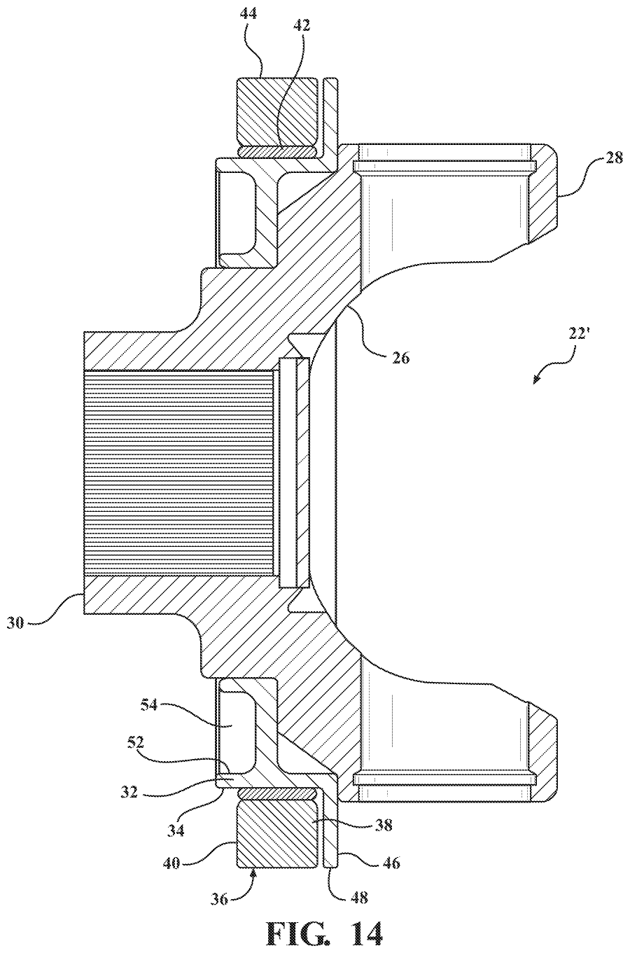

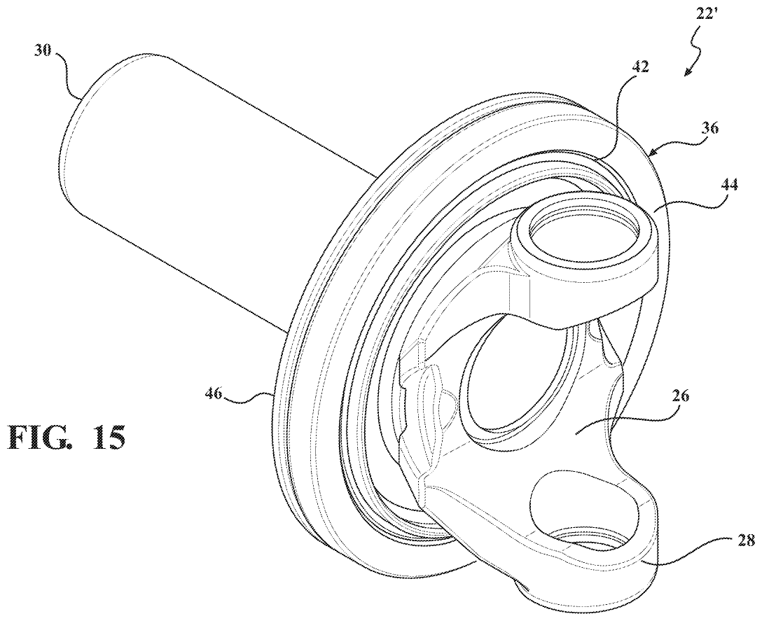

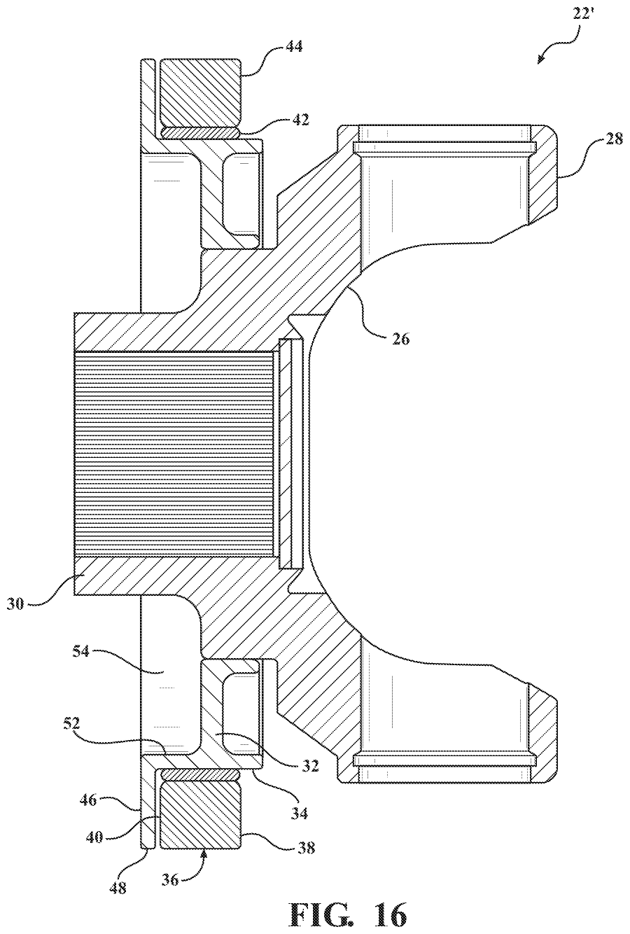

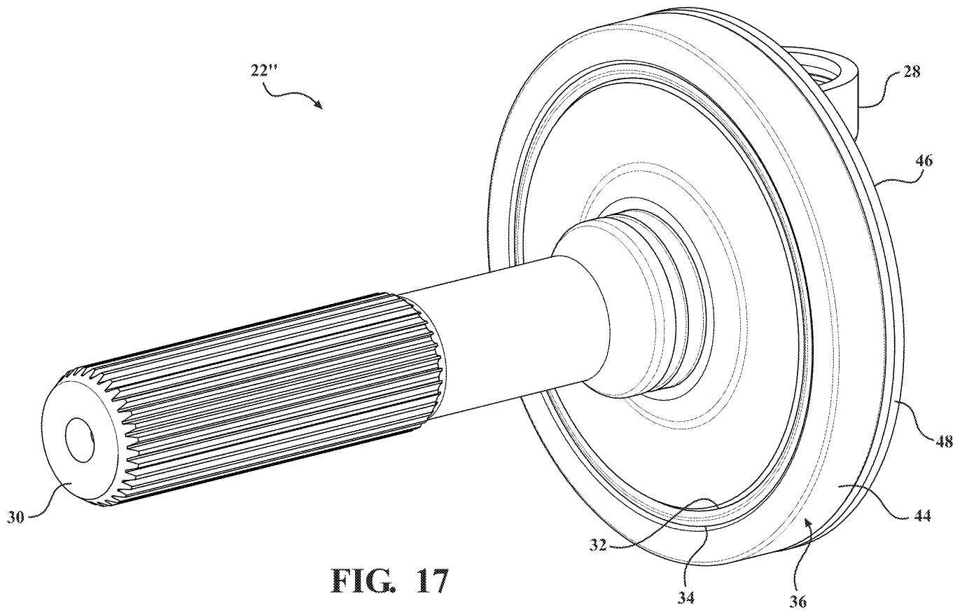

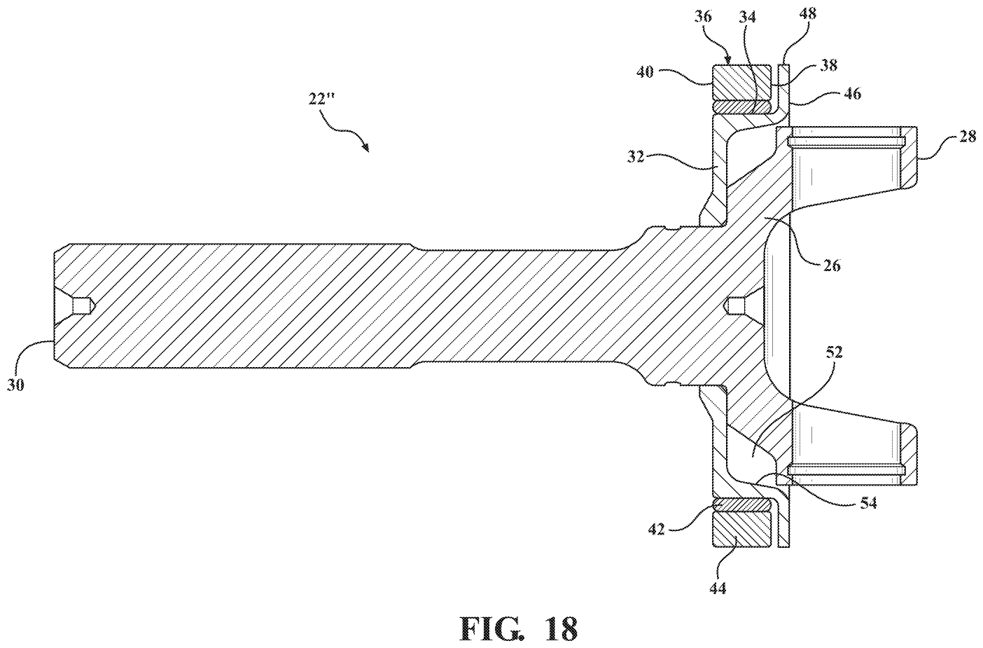

As best illustrated in FIGS. 1 and 2, the propeller shaft assembly 10 includes a propeller shaft 12 extending along an axis A between a first shaft end 14 having a first universal joint 16 and a second shaft end 18 having a second universal joint 20. Although the remaining disclosure of the exemplary embodiments will be described in relation to a one-piece propeller shaft, the teachings may also be practiced and applicable to a multi-piece propeller shaft without departing from the scope of the subject invention. A first propeller shaft yoke 22, such as a slip yoke 22′ (FIGS. 13-16 and 20) or a stud yoke 22″ (FIGS. 17-18), is coupled to the first universal joint 16 and may be further coupled to a powertrain transmission or transfer case of the vehicle for transmitting torque to the propeller shaft 12 from the powertrain transmission or transfer case. As understood by one of ordinary skill in the art, the slip yoke 22′ and the stud yoke 22″ are interchangeable components for the first propeller shaft yoke 22 depending on whether an internally splined yoke (i.e., a slip yoke 22′) or an externally splined yoke (i.e., a stud yoke 22″) is required to establish attachment of the propeller shaft 12 to the powertrain transmission or transfer case. A second propeller shaft yoke 24, such as flange yoke 24 (FIGS. 5-12 and 19), is coupled to the second universal joint 20 and may be further coupled to a differential of the vehicle for transferring torque from the propeller shaft 12 to the differential.

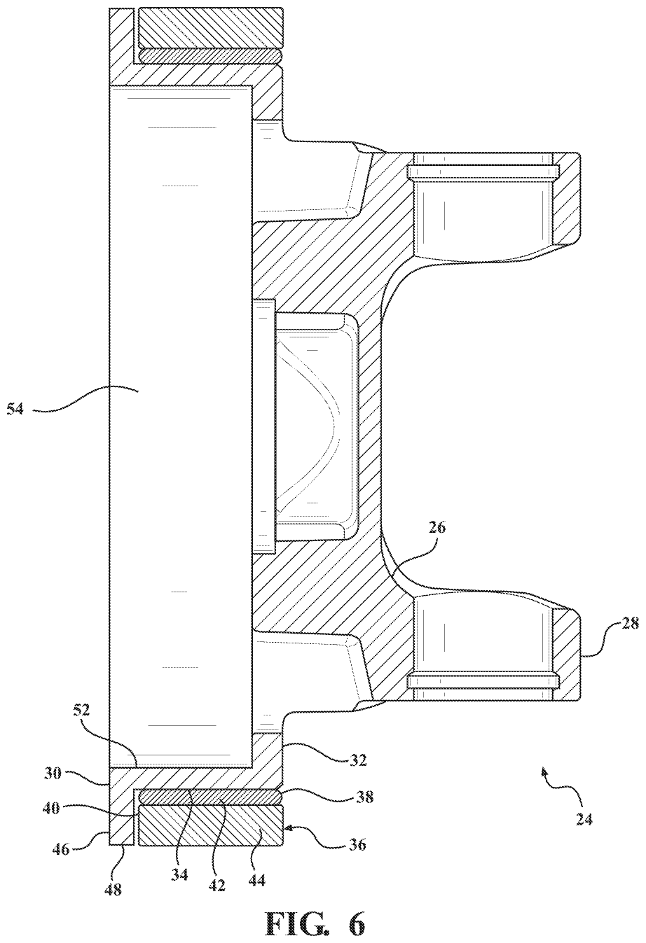

As best illustrated in FIGS. 5-20, each of the first and second propeller shaft yokes 22, 24 include a body 26 extending from a first yoke end 28 disposed adjacent and operably coupled with a respective shaft end 14, 18 of the propeller shaft 12 to a second yoke end 30 for coupling with the corresponding driveline component (e.g., the powertrain transmission, the transfer case, or the differential). The body 26 includes a mounting hub 32 presenting a mounting surface 34 extending preferably parallel with and circumferentially about the axis A. As best illustrated in FIGS. 5, 9, 12, and 19, in one arrangement the mounting hub 32 is integrally formed with the body 26 of the propeller shaft yoke 22, 24. However, as best illustrated in FIGS. 6, 14, 16, 18 and 20, in another arrangement the mounting hub 32 can be press-fit or otherwise joined with the body 26.

In either arrangement, and as illustrated in FIGS. 5-18, the mounting hub 32 accommodates a tuned damper 36 which extends radially outwardly from the mounting surface 34 of the propeller shaft yoke 22, 24 for reducing, cancelling or countering noise, vibration and/or harshness (NVH) generated during operation of the propeller shaft 12. For example, as best illustrated in FIGS. 13-18, the tuned damper 36 can be incorporated into the first propeller shaft yoke 22, such as in the slip yoke 22′ (FIGS. 13-16) or in the stud yoke 22″ (FIGS. 17-18). Alternatively, and as best illustrated in FIGS. 5-12, the tuned damper 36 can be incorporated into the second propeller shaft yoke 24, such as in the flange yoke 24. In either arrangement, the tuned damper 36 extends upwardly from the mounting surface 34 to define a first damper side 38 disposed adjacent the first yoke end 28 for facing the propeller shaft 12 and a second damper side 40 disposed adjacent the second yoke end 30 for facing the driveline component to which the respective propeller shaft yoke 22, 24 is to be coupled.

In a preferred arrangement, the tuned damper 36 includes a first damper ring 42 and a second damper ring 44. The first damper ring 42 is disposed in encircling and abutting relationship with the mounting surface 34 of the propeller shaft yoke 22, 24 and is comprised of a flexible material, such as plastic, synthetic or natural rubber, or elastomeric material. The second damper ring 44 is disposed in encircling and abutting relationship with the first damper ring 42 and is comprised of a light-weight steel or iron material. Due to the flexible configuration of the first damper ring 42, it may be disposed via an interference fit between the mounting surface 34 of the propeller shaft yoke 22, 24 and the second damper ring 44. The size and weight of both the first damper ring 42 and the second damper ring 44 are selectively chosen based on the frequency of vibration present at the propeller shaft yoke 22, 24. In other words, depending on the type, amount and/or magnitude of the offensive and/or unwanted NVH that is being reduced and/or cancelled, a mass and/or material of the first and second damper rings 42, 44 can be changed to correspond with the desired performance of the tuned damper 36.

As best illustrated in FIGS. 5-18, the mounting hub 32 of the propeller shaft yoke 22, 24 includes a protective shoulder 46 extending radially outwardly from the mounting surface 34 in spaced and covering relationship with either a first or second damper side 42, 44 of the tuned damper 36 to provide a mechanical protective shield for the tuned damper 36 that absorbs an axial impact directly and prevents dislodging of the tuned damper 36 from the axial forces applied during contact with another object, whether during shipping, vehicle assembly, or vehicle use. Put another way, the addition of the protective shoulder 46 to the propeller shaft yoke 22, 24 provides a more robust and cost-effective method of preventing a tuned damper 36, or any of its damper ring components 42, 44, from being dislodged from an axial impact during vehicle use or shipping and handling of the propeller shaft assembly 10. Additionally, the incorporation of the protective shoulder 46 into the propeller shaft yoke 22, 24 allows the tuned damper 36 to be retained using the conventional approach involving radial compression of the tuned rubber element, without the added expense of adhesive bonding, heat curing and related preparation steps required by the prior art propeller yoke designs and methods of manufacturing same. Accordingly, the protective shoulder 46 provides improved protection of the tuned damper 46 on the propeller shaft yoke 24, 24, with a lower cost implementation, relative to the prior art designs.

As noted above, the protective shoulder 46 is disposed in slightly spaced relationship with the tuned damper 36 to avoid interference of the protective damper 46 with operation of the tuned damper 36 during normal operation of the propeller shaft yoke 22, 24. However, the protective shoulder also provides a rigid stop to limit displacement of the second damper ring 46 (i.e., the mass inertia ring) during an axial impact in a direction opposite to the axial force discussed above in relation to the protective shoulder 46 and thus directly impacting the tuned damper 36. As the first damper ring 44 distorts elastically as a result of this impact, the second damper ring 46 engages and is stopped by the protective shoulder 46, allowing the second damper ring 46 to elastically spring back to its original position after the axial impact. The protective shoulder 46 preferably terminates at a shoulder end disposed adjacent and aligned with an outer surface of the second damper ring 44. However, the protective shoulder 46 could extend radially past the second damper ring 44 of the tuned damper 36 without departing from the scope of the subject disclosure.

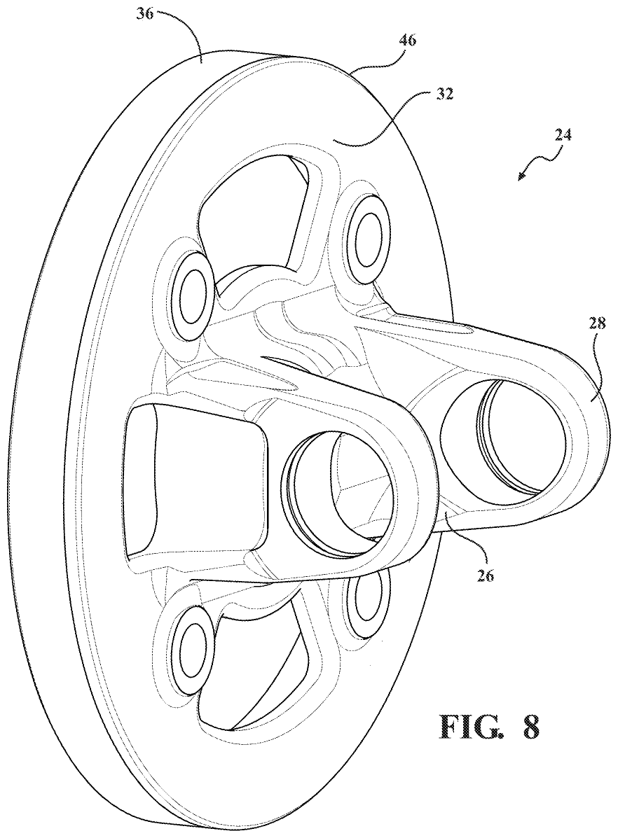

As best illustrated in FIGS. 8-14 and 17-18 in one arrangement, the protective shoulder 46 can extend along the first damper side 38 of the tuned damper 36 to protect the tuned damper 36 from an axial impact originating in a direction from the propeller shaft 12 towards the propeller shaft yoke 22, 24. However, as best illustrated in FIGS. 5-7 and 15-16, in another arrangement, the protective shoulder 46 can extend along the second damper side 40 of the tuned damper to protect the tuned damper 36 from an axial impact originating in a direction from the driveline component, and thus relatedly from the second yoke end 30 of the propeller shaft yoke 22, 24, towards the propeller shaft 12. Orientation of the protective shoulder 46 along either the first or second damper sides 38, 40 provides flexibility relative to designing the propeller shaft yokes 22, 24 to absorb the axial impacts common to a certain driveline application, i.e., either from the front or rear oriented direction relative to the propeller shaft 12 and its arrangement in the vehicle.

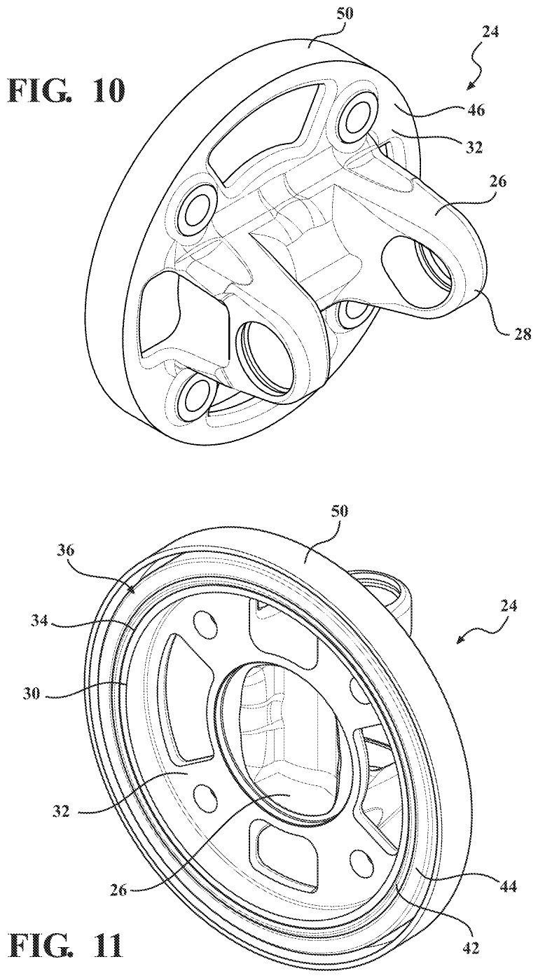

As best illustrated in FIGS. 10-12, an axial flange 50 can extend axially from the shoulder end 48 of the protective shoulder 46 in spaced and overlaying relationship with the second damper ring 44 to provide a radial shield for the tuned damper 36, further protecting the tuned damper 36 from radial forces as well as rocks, stones, and other debris encountered by the propeller shaft yoke 22, 24 during normal operation. Additionally, the axial flange 50 prevents mud and other debris from accumulating in the propeller shaft yoke 22, 24 and negatively impacting its performance. Although the axial flange 50 is only illustrated in FIGS. 10-12, the axial flange 50 can also be incorporated into the other arrangements of the propeller shaft yoke 22, 24 illustrated in FIGS. 5-9 and 13-18 without departing from the scope of the subject disclosure.

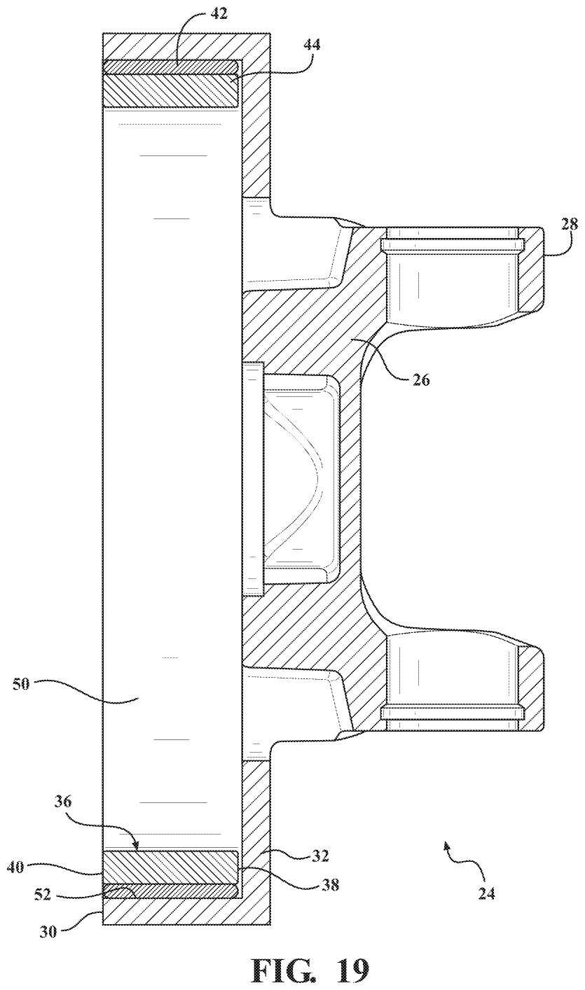

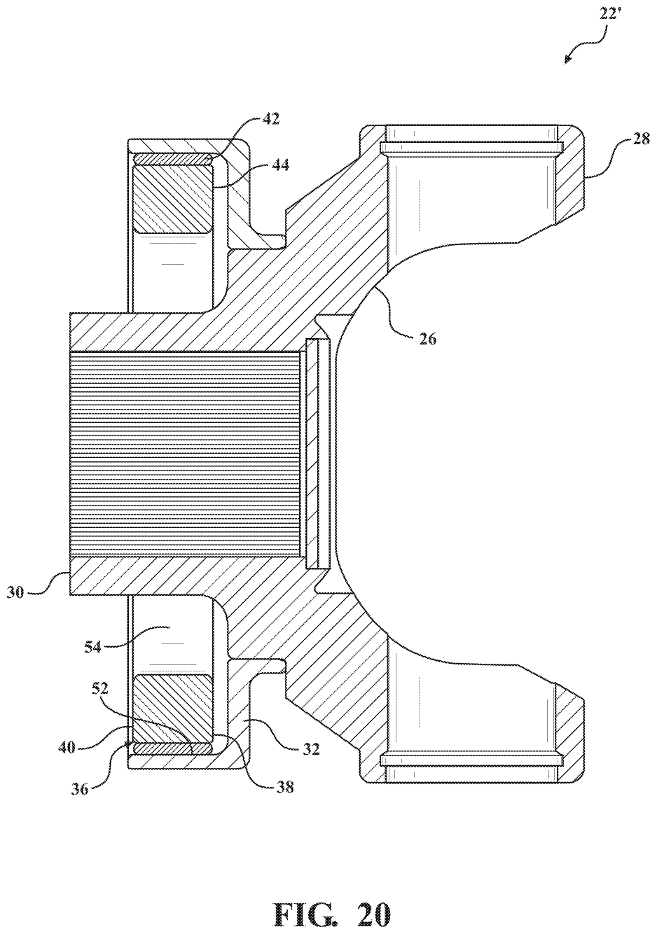

As illustrated in FIGS. 6,-7, 9, 11-12, 14, 16 and 18-20, the mounting hub 32 of the propeller shaft yoke 22, 24 presents an internal surface 52 disposed in facing and encircling relationship with the axis A to define an internal hub cavity 54. As best illustrated in FIGS. 19 and 20, in an alternative embodiment, the tuned damper 36 can be mounted within the internal hub cavity 54 along the internal surface 52 to provide an alternative means for protecting the tuned damper 36 from both the axial and radial forces. In other words, mounting of the tuned damper 36 within the internal hub cavity 54 employs encapsulation of the tuned damper 36 which also achieves a “radial shield” to protect the tuned damper from radial forces and debris, while also protecting the tuned damper from axial forces, such as by way of the related yoke in which the tuned damper 36 is mounted. Thus, mounting of the tuned damper 36 within the internal hub cavity 54 provides an alternative arrangement of providing the additional radial protection discussed previously in accordance with FIGS. 10-12. In this arrangement, the tuned damper 36 extends radially inwardly from the internal surface 52 of the mounting hub 32 for reducing, cancelling or countering noise, vibration and/or harshness (NVH) generated during operation of the propeller shaft 12. Similar to the other embodiments, the tuned damper 36 also includes a first damper ring 42 and a second damper ring 44, with the first damper ring 42 disposed in encircling and abutting relationship with the internal surface 52 of the mounting hub 32, the second damper ring 44 disposed in encircling and abutting relationship with the first damper ring 42, and the tuned damper 36 mounted to the internal surface 52 via an interference fit.

Obviously, many modifications and variations of the present invention are possible in light of the above teachings and may be practiced otherwise than as specifically described. Individual elements or features of a particular embodiment are generally not limited to that particular embodiment, but, where applicable, are interchangeable and can be used in a selected embodiment, even if not specifically shown or described.

What is claimed is:

1. A propeller shaft assembly for connection to a vehicle driveline component, the propeller shaft assembly comprising:
a propeller shaft extending along an axis between a first shaft end and a second shaft end;
a propeller shaft yoke operably connected to one of said first or second shaft ends of said propeller shaft;
said propeller shaft yoke including a body extending from a first yoke end disposed adjacent said respective first or second shaft end to a second yoke end for coupling with the vehicle driveline component;
said body presenting a mounting surface extending circumferentially about said axis;
a tuned damper extending radially outwardly from said mounting surface to define a first damper side disposed adjacent said first yoke end and a second damper side disposed adjacent said second yoke end; and
a protective shoulder extending radially outwardly from said mounting surface in spaced and covering relationship with one of said first or second damper sides of said tuned damper for protecting said tuned damper from axial forces originating from a respective first or second yoke end of said propeller shaft yoke.

2. The propeller shaft assembly as set forth in claim 1, wherein said protective shoulder extends along said first damper side of said tuned damper.

3. The propeller shaft assembly as set forth in claim 1, wherein said protective shoulder extends along said second damper side of said tuned damper.

4. The propeller shaft assembly as set forth in claim 1, wherein said propeller shaft yoke is a slip yoke operably connected to said first shaft end of said propeller shaft.

5. The propeller shaft assembly as set forth in claim 1, wherein said propeller shaft yoke is a stud yoke operably connected to said first shaft end of said propeller shaft.

6. The propeller shaft assembly as set forth in claim 1, wherein said propeller shaft yoke is a flange yoke operably connected to said first or second shaft end of said propeller shaft.

7. The propeller shaft assembly as set forth in claim 1, further comprising an axial flange extending axially from said protective shoulder and disposed in spaced and overlaying relationship with said tuned damper for protecting said tuned damper from radial forces and debris encountered by said propeller shaft yoke during operation.

8. A propeller shaft yoke comprising:
a body extending along an axis from a first yoke end for coupling with a propeller shaft and a second yoke end for coupling with a vehicle driveline component;
said body presenting a mounting surface extending circumferentially about said axis;
a tuned damper extending radially outwardly from said mounting surface to define a first damper side disposed adjacent said first yoke end and a second damper side disposed adjacent said second yoke end; and
a protective shoulder extending radially outwardly from said mounting surface in spaced and covering relationship with one of said first or second damper sides of said tuned damper for protecting said tuned damper from axial forces originating from a respective first or second yoke end of said propeller shaft yoke.

9. The propeller shaft yoke as set forth in claim 8, wherein said protective shoulder extends along said first damper side of said tuned damper.

10. The propeller shaft yoke as set forth in claim 8, wherein said protective shoulder extends along said second damper side of said tuned damper.

11. The propeller shaft yoke as set forth in claim 8, wherein said propeller shaft yoke is a slip yoke.

12. The propeller shaft yoke as set forth in claim 8, wherein said propeller shaft yoke is a stud yoke.

13. The propeller shaft yoke as set forth in claim 8, wherein said propeller shaft yoke is a flange yoke.

14. The propeller shaft yoke as set forth in claim 8, further comprising an axial flange extending axially from said protective shoulder and disposed in spaced and overlaying relationship with said tuned damper for protecting said tuned damper from radial forces and debris encountered by said propeller shaft yoke during operation.
